(19) United States
(12) Patent Application Publication
(10) Pub. No.: US 2025/0312637 A1
(43) Pub. Date: Oct. 9, 2025

(54) Method for Operating an Extinguishing System

(71) Applicant: Albert Orglmeister, Wiesbaden (DE)

(72) Inventor: Albert Orglmeister, Wiesbaden (DE)

(21) Appl. No.: 18/866,663

(22) PCT Filed: May 10, 2023
(86) PCT No.: PCT/EP2023/062392

§ 371 Date: Nov. 18, 2024

(30) Foreign Application Priority Data
May 29, 2022 (DE) 10 2022 113 478.4
Oct. 19, 2022 (DE) 10 2022 127 470.5

(51) Int. Cl. A62C 37/36; A62C 31/02; G01J 5/00; G01J 5/48; G01J 5/60; G01J 5/80

(52) U.S. Cl. CPC A62C 37/36; A62C 31/02; G01J 5/0066; G01J 5/48; G01J 5/605; G01J 5/80

(57) ABSTRACT

A method for operating an extinguishing system comprises—an electronic controller (15) with a computer module (18) for data processing and a memory device (17), wherein the controller (15) comprises an image processing device which receives and evaluates data from a camera (8), —at least one extinguishing agent dispenser (9) connected to the controller, which extinguishing agent dispenser is connected to an extinguishing agent line for supplying extinguishing agent and—at least one camera (8) connected to the controller. The image processing device evaluates image regions that indicate a hotspot (6) with regard to isothermal regions (22), compares these regions (22) with stored patterns and, depending on the comparison, controls the extinguishing agent dispenser (9) to discharge extinguishing agent or prevents the discharge of extinguishing agent.

### CROSS REFERENCE TO RELATED APPLICATIONS

This application is the U.S. national stage of International Application No. PCT/EP2023/062392, filed on 2023 May 10. The international application claims the priority of DE 102022113478.4 filed on 2022 May 29 and the priority of DE 102022127470.5 filed on 2022 Oct. 19; all applications are incorporated by reference herein in their entirety.

### BACKGROUND

The invention relates to a method for operating an extinguishing system with
an electronic controller with a computer module for data processing and a memory device, wherein the controller comprises an image processing device which receives and evaluates data from the camera,
at least one extinguishing agent dispenser connected to the controller, which extinguishing agent dispenser is connected to an extinguishing agent line for supplying extinguishing agent
and at least one camera connected to the controller,

Usually, a fire in a warehouse, for example, is detected at a fire alarm temperature of 80° C. and an extinguishing system is switched on, which sprays or floods a large amount of extinguishing agent, e.g., water or extinguishing foam, into the fire region and thus extinguishes the fire. In particular sprinkler systems and considerably more powerful spray flood systems or extinguishing monitors, which are also known as fire extinguishing cannons or water cannons, are used as extinguishing systems. In the scope of the present application, all extinguishing systems are referred to individually and collectively as extinguishing agent dispensers.

Due to the large amount of extinguishing agent that is released relatively quickly, relatively great damage can occur, so that false extinguishing must be avoided while maintaining the highest possible level of safety for reliable firefighting.

Thermal interference that can lead to false extinguishing are caused, for example, by a hot exhaust or a hot engine of a wheel loader. During operation, high temperatures above the fire alarm temperature are reached relatively quickly.

From WO 2011/103915 A1, a device for thermal monitoring, in particular for large warehouses, waste incineration plants, production facilities and the like, by means of an extinguishing system for extinguishing a fire is known. The extinguishing system consists of a combination of one or more infrared cameras and one or more controllable fire extinguishing cannons in the monitored room, with at least one infrared camera detecting a fire. The fire source is pinpointed in the initial phase using intelligent evaluation software and, based on the temperature increase detected by the infrared camera in the initial phase, is automatically extinguished using at least one intelligently controlled fire extinguishing cannon.

Furthermore, EP 3 167 937 A1 discloses a method for eliminating thermal interference in infrared and video early fire detection in waste incineration plants, recycling plants, open-air storage facilities and the like. This method uses a noise or vibration analysis of vehicles or other thermal interference sources, such as machine drive motors, located in the region to be detected in order to be able to distinguish between a fire and a thermal disturbance using the noise pattern (e.g., that of a wheel loader exhaust) in the case of an object whose temperature is above the fire alarm temperature. Furthermore, a distinction is made between daytime operation and nighttime operation by measuring the noise level. During nighttime operation, for example, there are no vehicles driving around and therefore significantly fewer interference.

Extinguishing systems are known, for example, from DE 10 2016 104 349 A1, DE 10 2011 053 373 A1 and DE 21 2010 000 060 U1 and are increasingly being used to protect waste bunkers and storage facilities both outdoors and indoors. For fire detection or early fire detection, these predominantly automatic extinguishing systems comprise at least one camera, which is usually arranged on the top, for example on a room ceiling or on a mast or the like, and is pivoted across the surface to be monitored. If a fire source, a smoldering ember or a region with an unusually high temperature for the material to be monitored, which indicates an initial fire, possibly even in a deeper region below the thermographically monitored surface, is detected (these locations of higher temperature are also referred to below as hot spots), the controller directs an extinguishing agent dispenser at this fire source and opens a valve so that the extinguishing agent flows out under a relatively high pressure and in a relatively large amount. Due to inaccuracies in the detection of the fire source and in the aiming of the extinguishing agent dispenser, the extinguishing agent dispenser often sweeps vertically and/or horizontally in order to extinguish the fire source.

DE 102 53 360 A1 shows an early fire detection system with an infrared radiation detection device which has a geometric resolution of no more than 1 cm×1 cm, a swivel device which is coupled to the infrared radiation detection device in such a way that an surface is scanned row by row and/or column by column by the infrared radiation detection device, a comparison device which compares an output signal of the infrared radiation detection device with a predetermined threshold value in accordance with the amount of energy of the infrared radiation detected and determines whether the output signal of the infrared radiation detection device exceeds the threshold value, an output device which, in response to a signal from the comparison device, outputs an exceedance of the threshold value and coordinates of a region of the scanned surface from which infrared radiation is emitted, which has led to the threshold value being exceeded, and a control device which controls and coordinates the infrared radiation detection device, the swivel device, the comparison device and the output device.

Furthermore, KR 10 1 297 121 B1 discloses a tunnel fire detection apparatus using an infrared image with an infrared camera, an infrared image acquisition and preprocessing unit. Furthermore, KR 10 0 690 661 B1 describes a fire extinguishing apparatus and a method in which a fire is detected using a heat sensor, wherein a shape and color pattern of a heat source is extracted using a camera when the fire is detected. The pattern is compared with a preset fire pattern and the fire is automatically evaluated according to the comparison result.

### SUMMARY

A method for operating an extinguishing system comprises—an electronic controller (15) with a computer module (18) for data processing and a memory device (17), wherein the controller (15) comprises an image processing device which receives and evaluates data from a camera (8), —at least one extinguishing agent dispenser (9) connected to the controller, which extinguishing agent dispenser is connected to an extinguishing agent line for supplying extinguishing agent and—at least one camera (8) connected to the controller. The image processing device evaluates image regions that indicate a hotspot (6) with regard to isothermal regions (22), compares these regions (22) with stored patterns and, depending on the comparison, controls the extinguishing agent dispenser (9) to discharge extinguishing agent or prevents the discharge of extinguishing agent.

### DETAILED DESCRIPTION

The invention is based on the object of creating a method of the type mentioned at the outset with which interference in optical fire detection is reduced, in particular, by distinguishing critical hotspots from non-critical hotspots.

Within the meaning of the invention, a hotspot is understood to be a hot spot above a critical temperature, for example, the fire pre-alarm temperature and/or the fire alarm temperature, which can be a fire source or another hot component in a monitoring region. The critical temperature is specified and stored in the memory device.

According to the invention, the object is achieved in that the image processing device evaluates image regions that indicate a hotspot with regard to isothermal regions, compares these evaluated regions with stored patterns and, depending on the comparison, controls the extinguishing agent dispenser to discharge extinguishing agent or prevents the discharge of extinguishing agent.

In regions equipped with fire extinguishing systems, such as storage, production, recycling or disposal sites, vehicles are often used which cause, in particular due to hot mufflers, a false alarm and possibly an associated false extinguishing, which must be avoided. The mufflers and/or exhaust pipes and/or engine and/or transmission blocks of vehicles designed as wheel loaders, for example, are generally relatively exposed to the monitoring cameras, which may be designed as video cameras or infrared cameras, and, depending on the manufacturer and/or type, often have similar geometries and, during operation, often similar temperature profiles, which may present and may also be recognized as thermal images, wherein the thermal images are relatively clearly and simply structured if an evaluation is carried out according to isotherms and temperature ranges are defined at the controller or the image processing apparatus, which are displayed and/or evaluated in one color, a shade of gray, a line and/or dot pattern or the like.

In order to avoid or reduce false extinguishing, images can be taken as patterns, in particular of the vehicles used within the monitoring region or their hot components, which may cause an alarm due to a temperature above the stored limit temperature for a fire alarm, and similar to the actual image processing, temperature ranges can be defined which have characteristic geometries and/or surfaces in an isothermal representation. These patterns can be created, for example, by means of reference thermal images or by calculating thermal conditions.

The image processing device is able to display the isothermal regions of the actual thermal images available in real time on a screen and compare them with the stored patterns. If the comparison produces a result that indicates a known hot component, such as a muffler, a gearbox or an engine block, the extinguishing agent dispenser is not activated to discharge extinguishing agent. For example, an alarm may be triggered on a screen to allow for an optical inspection by a human observer and, if necessary, manual control of the extinguishing agent dispenser to dispense extinguishing agent. If the comparison of the image with the isothermal regions with the stored patterns does not allow any conclusion to be drawn about a known and non-critical heat source, i.e., a hotspot, then the extinguishing agent dispenser is activated to discharge extinguishing agent. The stored patterns represent known and non-critical heat sources.

When evaluating the images of the isothermal regions, it is expedient to take into account both temperature zones and/or temperature ranges as well as surfaces of the corresponding temperature zones and/or temperature ranges. This is done on the computer side in order to simplify the representation and evaluation of the regions of interest if necessary.

Furthermore, it is expedient to compare the actual regions with the patterns stored as geometric patterns and/or color gradient and/or temperature gradient patterns.

According to a further development, a noise and/or vibration analysis is carried out at the controller by detecting at least one noise pattern or by measuring the noise level of vehicles or other thermal interference sources, such as drive motors of machines, located in the region to be detected, wherein the volume thresholds are determined when measuring or detecting noise patterns, for example, and said volume thresholds are used as threshold values to decide whether fire extinguishing is triggered. Of course, a vibration analysis of the monitored room is also carried out using vibration sensors, and the corresponding actual data is compared with threshold values and/or patterns at the controller in order to cause the triggering of the activation of at least one extinguishing agent dispenser to discharge extinguishing agent if the threshold values are exceeded or if there are deviations from the stored patterns. For noise or vibration analysis, analog and/or digital filters, directional microphones, external microphones for a 3-dimensional noise pattern, fire-specific noise filters and/or vibration sensors are used, which are connected to the controller or implemented in the controller. When using analogue and/or digital filters in noise analysis, it is possible to identify which vehicle or type of vehicle, e.g., wheel loader, truck or the like, is in the region to be detected or whether it is a specific operating region of a plant to be monitored. This can also be used to filter out noises from outside the plant. If at least one directional microphone is used in parallel with the infrared or video analysis, the interference can be spatially assigned to the currently detected object. When using multiple external microphones, a 3-dimensional noise pattern can also provide information about the devices being operated and include them in the analysis.

In an embodiment, the image processing device can be switched into a work mode and a sleep mode, wherein in the sleep mode the controller controls the extinguishing agent dispenser to dispense extinguishing agent independently of a comparison of the isotherms of hotspots in images of the camera designed as a thermal imaging camera or video camera, which isotherms are evaluated by the image processing device with stored patterns. For example, switching from work mode to sleep mode can be set based on times and calendar dates. During working hours, thermal interference and the associated appearance of images, in particular thermal images, which may indicate a warm component of a vehicle are possible. During rest periods, i.e. in particular at night, on weekends and public holidays or the like, this thermal interference with the associated thermal images cannot usually occur and the at least one extinguishing agent dispenser is controlled to discharge extinguishing agent without further data comparison of actual images with patterns or sample images.

According to a further development, to dispense extinguishing agent, the extinguishing agent dispenser is controlled using an input device connected to the controller independently of a comparison of the isotherms of hotspots in camera images, which isotherms are evaluated by the image processing device with stored patterns. The input device may, for example, comprise a touchscreen, a joystick or the like and substantially allows for overriding the controller. This means that operating personnel can influence the discharge direction and/or the discharge quantity of extinguishing agent from an extinguishing agent dispenser independently of data from the controller or the image processing device in order to reliably extinguish a fire that has been optically detected on a monitor or touchscreen. Likewise, an extinguishing process, in particular the discharge of extinguishing agent by means of the extinguishing agent dispenser, can be terminated or prevented by means of the input device in the event of a false alarm that is optically detected by the operating personnel.

In order to scan the space to be observed, the camera, for example, an IR or video camera, is pivoted in an oscillating or continuously rotating manner about a mounting axis and the data of the resulting thermal image is transmitted to the image processing device. When the camera is pivoted, for example, a distorted spherical image, or a circular image or a circular ring image is created, which allows the hotspots to be identified based on their coloring.

It is understood that the features mentioned above and still to be explained below can be used not only in the respectively specified combination but also in other combinations. The scope of the invention is defined only by the claims.

The invention is explained in more detail below on the basis of an embodiment with reference to the associated drawings.

### BRIEF DESCRIPTION OF THE DRAWINGS

In the drawings:

FIG. 1 is a schematic representation of a room to be monitored in which the method according to the invention can be applied and

FIG. 2 is a partial view of a hot component located in the monitored room, the detection of which should not cause the discharge of extinguishing agent.

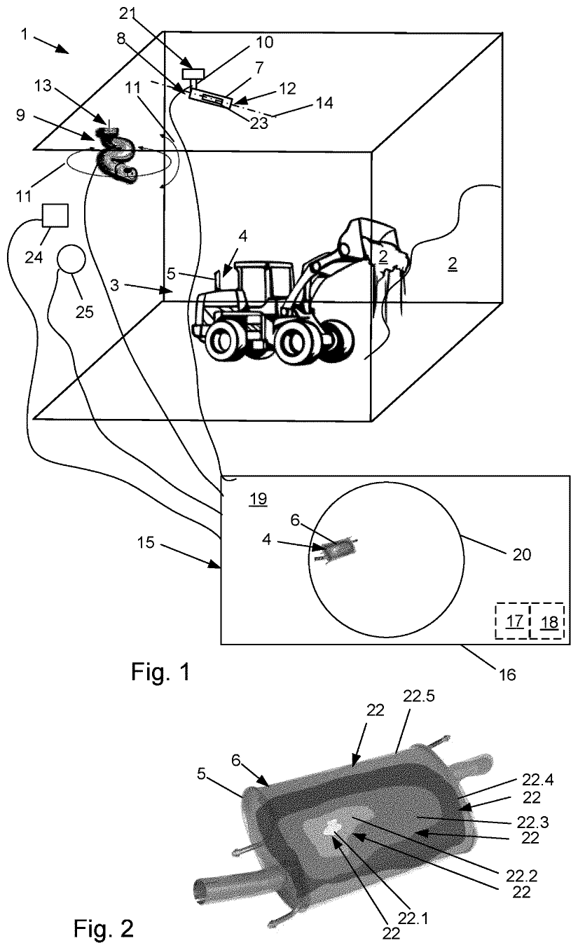

### DETAILED DESCRIPTION OF THE PREFERRED EMBODIMENTS

The method is used, for example, in a room 1 of a processing plant, for example, for the processing of recycling material or a waste incineration plant or a storage facility for combustible objects, for example, a storage area for rubber tires or wood or plastics materials or the like, or in a production facility. In the room to be monitored, material 2, for example, recycling material or garbage or stored goods, is usually transported with a wheel loader 3. Such a wheel loader 3, which is mentioned as an example for any motor vehicle, comprises at least one heat-generating combustion engine and an exhaust 4 which is warm during operation and has a generally characteristic muffler 5, wherein these heat-radiating components may be perceived as thermal interference, for example, so-called hotspots 6 which may represent the fire sources, in an image 20 which is formed as a thermographic image or a thermally evaluated video image or which is computer-processed by means of an image processing device or, of course, the image data thereof.

In order to monitor the monitored room 1, which can also be a warehouse or an outdoor storage area, for the occurrence of a fire in the existing stored material 2 and, if necessary, to start an automatic extinguishing of the fire, an extinguishing system is installed which substantially comprises a camera 8 designed as a thermal imaging camera 7, for example, an infrared camera, and an extinguishing agent dispenser 9, which can also be referred to as an extinguishing monitor or extinguishing dispenser. The camera 7 and the extinguishing agent dispenser 9 are fastened at specific locations in a defined position, in particular, in the room 1 and/or relative to one another, such that, for example, a mounting axis 10 of the camera 8, which, for example, comprises a lens 12, is aligned parallel to a mounting axis 13 of the extinguishing agent dispenser 9. The camera 7 can be pivoted, for example by means of an engine 21, in particular a stepper motor, by up to 360° around the mounting axis 10, in particular in an oscillating manner. Furthermore, the camera 8 or its optical axis 14 assumes a defined position relative to the mounting axis 10. If the room 1 to be monitored has special conditions, the camera 7 can be pivoted such that the axis 14 describes a larger or smaller angle to the mounting axis 10. Even in this position, the camera 8 can be pivoted by means of at least one associated engine 21, which may be designed as a stepper motor.

The extinguishing agent dispenser 9 can be pivoted about two axes, as indicated by the double arrows 11 associated with the extinguishing agent dispenser 9, namely about its mounting axis 13 and an axis aligned at an angle to it. The extinguishing agent dispenser 9 is connected to pipes or hoses for the extinguishing agent. Furthermore, the extinguishing agent dispenser 9 is coupled to an electronic controller 15, which is designed as a tablet computer 16 in the present case, and comprises at least one memory device 17 for the readable storage of data, a computer module 18 for data processing and a screen designed as a touchscreen 19, wherein the touchscreen 19 serves both as an input unit and for displaying the images 20 recorded by the thermal imaging camera 7, wherein the thermal imaging camera 7 is of course also connected to the tablet computer 16, which serves as the computer controller 15.

Of course, the at least one camera 8 and the at least one extinguishing agent dispenser 9 can be mounted on masts, room walls or room ceilings or the like, in particular, stationary components.

The basic geometric data of the room 1, which are measured on site as actual data, are stored in the memory device 17 of the electronic controller 15, in which the image processing device is also implemented. These basic geometric data of the room 1 describe the floor surface, i.e., the dimensions of the floor 3 and the height of the room 1. Furthermore, the coordinates at which the camera 7 and the extinguishing agent dispenser 8 are mounted are stored. In addition, standard dispensing curves determined by the manufacturer which describe the dispensing distances of the extinguishing agent under a certain pressure and specified extinguishing agent dispensing settings, as well as various software and image processing devices can be stored.

The software and image processing devices ensure the detection of a hotspot 6 that may develop into a fire. In order to avoid false extinguishing caused by known heat sources, for example the muffler 5 of the wheel loader 3 shown in the present example, image regions that indicate a hotspot 6 are evaluated on the image processing device with regard to isothermal regions 22 and these isothermal regions 22 or isothermal curves are compared with stored patterns. When evaluating the images of the isothermal regions 22, both temperature zones and/or temperature ranges as well as surfaces of the corresponding temperature zones and/or temperature ranges are taken into account. For example, a first isothermal region 22.1 with an average temperature of about 450° C. and a size of about 0.1 m², a second isothermal region 22.2 with an average temperature of about 350° C. and a size of about 0.15 m², a third isothermal region 22.3 with an average temperature of about 240° C. and a size of about 0.25 m², a fourth isothermal region 22.4 with an average temperature of about 170° C. and a size of about 0.4 m² and a fifth isothermal region 22.5 with an average temperature of about 120° C. and a size of about 0.5 m² can be recognized. At a fire alarm temperature of 70° C. or higher, each of these isothermal regions 22 of the muffler 5 of the wheel loader 3 would lead to an alarm and possibly a false extinguishing triggered by the controller 15. Since a pattern with a corresponding temperature/surface distribution is known at the image processing device, the image processing device concludes that the muffler 5 is the cause and does not trigger the discharge of extinguishing agent. Of course, an alarm can be triggered, for example, in the form of a pre-alarm on the tablet computer 16, which can be evaluated by operating personnel and, if necessary, overridden. It is obvious to a person skilled in the art that in addition to the temperature/surface distributions, characteristic geometric data can also be stored on the image processing device. If, in addition, corresponding data of various common mufflers of wheel loaders 3 or other motor vehicles or patterns of isothermal regions of engine blocks or the like (not shown) are stored and the image data recorded with the camera 8 are evaluated at the controller 15 with the image processing device according to their occurrence, a large number of false extinguishing operations can be avoided.

In order to be able to take into account temperature changes or temperature profile changes or surface changes that represent deviations of the corresponding actual data from the stored patterns and at different ambient temperatures, the ambient temperature is also measured and a corresponding value is applied to the controller 15, which takes this ambient temperature into account when comparing the actual isothermal regions 22 with stored patterns, for example with a factor associated with the ambient temperature. Said factor takes into account, in particular, the fact that the pattern was created on the basis of, for example, an ambient temperature of 20° C. or was recorded with a camera and the actual isothermal regions 22 can be, for example, colder and/or smaller at a relatively low ambient temperature and, for example, warmer and/or larger at a relatively high ambient temperature.

Further changes may result from changing distances, for example, of the muffler 5 or another heat source to the camera 8 or from lens-related distortion. These changes can be taken into account by the image processing device insofar as the percentage reference values of the individual isothermal regions 22 remain the same to one another and are accordingly comparable with the stored patterns.

In order for operating personnel to be able to quickly and reliably identify the relevant heat sources, which represent hotspots 6, on the tablet computer 16, the thermal images evaluated by the image processing device are displayed on the screen as color-graded isothermal regions 22.

Overall, the extinguishing of the hotspots 6, which represent fire sources and are not marked as known by the image processing device, takes place automatically by the controller 15 directing the extinguishing agent dispenser 9 to the hotspot 6 and controlling it to discharge extinguishing agent.

In order for operating personnel to be able to override this automatic extinguishing operation, directing and controlling of the extinguishing agent dispenser 9 for extinguishing is provided by means of the touchscreen 19 and/or a joystick as an input device on a computer with an associated screen.

In order to achieve a relatively high level of safety, the controller 15 with the image processing device can be switched into at least one work mode and one sleep mode, wherein in the sleep mode the controller 15 controls the extinguishing agent dispenser 9 to dispense extinguishing agent independently of a comparison of the isothermal regions 22 of hotspots 6 in images of the thermal imaging camera 7, which isothermal regions are evaluated at the image processing device, with the stored patterns, and different isothermal characters are evaluated in the various work modes. Thus, it is also possible that the sleep mode is defined as a special work mode and/or that such a sleep mode can be switched on, for example, during non-working hours, in which there are usually no known heat sources in the room 1 to be monitored and a hotspot 6 is therefore very likely to be a fire source.

At least the camera 8 is associated with a laser 23 which is directed in the image recording direction and which can be designed for distance measurement and/or for emitting a pulsed laser beam.

The position of the hotspot 6 recorded by the camera 7 can be described with a relatively low computational effort and the extinguishing agent dispenser 9 can be tracked relatively precisely, since, in particular, the mounting axes 10, 13 on both sides are aligned parallel to one another, resulting in less important deviations or errors due to the different mounting points, as long as the distance between the extinguishing agent dispenser 9 and the camera 7 is relatively small, for example, up to a distance of about 5 m, preferably up to about 2 m. However, the error is usually so small that the fire can be extinguished at this point using the extinguishing agent. The error corresponds to a maximum of the distance between an axis 14 of the camera 7 and a quasi exit axis of the extinguishing agent dispenser 8. In terms of height, the camera 7 and the extinguishing agent dispenser 8 may be offset from each other, for example, offset by approx. 1 m, so that the extinguishing agent dispenser 8 does not destroy the camera 7 with extinguishing agent, for example. The difference in height is relatively unimportant for the actual accuracy. In the case of larger, significant differences in height, the vertical angular offset of the extinguishing agent dispenser 8 can be calculated via the controller 15 or the extinguishing agent dispenser 8 can be pivoted vertically over a larger region.

Using the stored actual data and the coordinates of the mounting points of the camera 8 and the extinguishing agent dispenser 9 as well as the distance data, which are determined, for example, by means of the laser 23, all points in the room 1 can be calculated at the controller 15, for example, by means of triangulation, and the extinguishing agent dispenser 8 can be quickly directed by appropriately controlling the engines 21 associated with it, so that a fire source can be extinguished.

In normal operation or standard operation, the camera 7 is continuously pivoted to monitor the entire room 1, oscillating or rotating about the mounting axis 10, if necessary by up to 360°.

Of course, further detection means 23, for example for operating noises and/or vibrations, can be connected to the controller 15, which provide data to ensure reliable extinguishing of a fire and to avoid false extinguishing. If, for example, there are no known engine noises present at the controller, then there can be no known isothermal regions 22 in the room 1 to be monitored.

Of course, in such a monitoring operation, corresponding acoustic data or the like are stored, for example, on the memory device 17 of the controller 15, which can be associated, for example, with the wheel loader 3, or other known motor vehicles or operating equipment.

To further improve the detection accuracy of thermal interference sources and to reduce false extinguishing, a noise and/or vibration analysis is carried out at the controller 15 by recording and evaluating at least one noise pattern from vehicles or other thermal interference sources, such as drive motors of machines or the wheel loader 3, located in the region to be detected. To determine at least one noise pattern or noise level in the room 1 to be monitored, at least one microphone 24 is provided which is connected to the controller 15. To detect vibrations, at least one vibration sensor 25 is mounted in the room 1 to be monitored, which is connected to the controller 15, wherein the vibration sensor 25 may also be a special low-frequency microphone, for example.

The controller 15 evaluates the recorded volume and vibration data using analog and/or digital filters and compares them with threshold or limit values or patterns, in particular noise patterns, stored in the memory device 17 in order to control the at least one extinguishing agent dispenser to discharge extinguishing agent if the threshold values are exceeded or in the event of deviations from the stored patterns and a comparison with the patterns of the isothermal regions 22, if it is concluded that a fire source is present at the control unit 15.

### LIST OF REFERENCE NUMERALS

1. Processing plant
2. Material
3. Wheel loader
4. Exhaust
5. Muffler
6. Hotspot
7. Thermal imaging camera
8. Camera
9. Extinguishing agent dispenser
10. Mounting axis of 7
11. Double arrow
12. Lens
13. Mounting axis of 8
14. Axis
15. Controller
16. Tablet computer
17. Memory device
18. Computer module
19. Touchscreen
20. Image
21. Engine
22. Isothermal region
23. Laser of 7
24. Microphone
25. Vibration sensor

The invention claimed is:

1. A method for operating an extinguishing system with
an electronic controller (15) with a computer module (18) for data processing and a memory device (17), wherein the controller (15) comprises an image processing device which receives and evaluates data from a camera (8),
at least one extinguishing agent dispenser (9) connected to the controller, which extinguishing agent dispenser is connected to an extinguishing agent line for supplying extinguishing agent and
at least one camera (8) connected to the controller,
characterized in that the image processing device evaluates image regions which indicate a hotspot (6) with regard to isothermal regions (22), compares these regions (22) with stored patterns and, depending on the comparison, controls the extinguishing agent dispenser (9) to discharge extinguishing agent or prevents the discharge of extinguishing agent.

2. The method according to claim 1, characterized in that when evaluating the images of the isothermal regions (22), both temperature zones and/or temperature ranges as well as surfaces of the corresponding temperature zones and/or temperature ranges are taken into account.

3. The method according to claim 1, characterized in that the comparison of the actual regions (22) is made with the patterns stored as geometric patterns and/or color gradient and/or temperature gradient patterns.

4. The method according to claim 1, characterized in that a measured ambient temperature value of the environment in which the camera (8) is located is applied to the controller (15) and the image processing device scales the isothermal regions (22) depending on the ambient temperature value.

5. The method according to claim 1, characterized in that the patterns are created and stored based on actual isotherms.

6. The method according to any of claim 1, characterized in that the thermal images with the color-graded isothermal regions (22) evaluated by the image processing device are output on a screen.

7. The method according to claim 1, characterized in that a noise or vibration analysis is carried out at the controller (15) by detecting at least one noise pattern and/or measuring the noise level of vehicles or other thermal interference sources, such as drive motors of machines, located in the region to be detected, wherein the volume thresholds are determined when detecting noise patterns or measuring the noise level and said volume thresholds are used as threshold values to decide whether fire extinguishing is triggered.

8. The method according to claim 1, characterized in that the image processing device can be switched into at least one work mode and one sleep mode, wherein in the sleep mode the controller (15) controls the extinguishing agent dispenser (9) to dispense extinguishing agent independently of a comparison of the isotherms of hotspots (6) in images of the camera (8), which isotherms are evaluated at the image processing device, with stored patterns.

9. The method according to claim 1, characterized in that with an input device connected to the controller (15), the extinguishing agent dispenser (9) is controlled to discharge extinguishing agent independently of a comparison of the isotherms of hotspots (6) in images of the thermal imaging camera (7), which isotherms are evaluated at the image processing device with stored patterns and/or the noise or vibration analysis.

10. The method according to claim 1, characterized in that the camera (8) is pivoted in an oscillating or rotating manner about a mounting axis (10) and the data of the resulting thermal image are transmitted to the image processing device.
